(19) United States
(12) Patent Application Publication
(10) Pub. No.: US 2017/0078047 A1
(43) Pub. Date: Mar. 16, 2017

(54) Transmitter Distortion Management

(71) Applicant: MagnaCom Ltd., Petach Tikva (IL)

(72) Inventor: Roy Oren, Magshimim (IL)

(21) Appl. No.: 14/851,162

(22) Filed: Sep. 11, 2015

(51) Int. Cl. H04L 1/00; H04L 27/12

(52) U.S. Cl. CPC H04L 1/0041; H04L 27/12

(57) ABSTRACT

A transmitter comprises: sequence transformation circuitry operable to apply a first and second transformation sequences to first and second data bits, respectively, to generate first and second transformed data bits; FEC encoder circuitry operable to generate redundancy bits based on the first transformed data bits, one or more first index bits representing an index of the first transformation sequence, the second transformed data bits, and one or more second index bits representing an index of the second transformation sequence, and output a codeword comprising the first transformed data bits, the first index bits, the second transformed data bits, the second index bits, and the redundancy bits; and modulator circuitry operable to generate first and second OFDM symbols carrying the first and second transformed data bits, respectively, the first and second index bits, respectively, and first and second portions of the redundancy bits, respectively.

### INCORPORATION BY REFERENCE

The entirety of each of the following applications is hereby incorporated herein by reference:

U.S. patent application Ser. No. 14/713,091 titled “Distortion Reduction Scheme for Transmission of Data” filed on May 15, 2015.

### BACKGROUND

Conventional communication methods and systems suffer severe performance degradation in the presence of nonlinear distortion. The nonlinear distortion that may be originated by analog and RF components may cause sensitivity loss at the receiver as well as spectral regrowth that may exceed spectral mask limitations and interfere with adjacent channels. Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Systems and methods are provided for transmitter distortion management, substantially as shown in and/or described in connection with at least one of the figures, as set forth more completely in the claims.

These and other advantages, aspects and novel features of the present invention, as well as details of an illustrated implementation thereof, will be more fully understood from the following description and drawings.

### BRIEF DESCRIPTION OF SEVERAL VIEWS OF THE DRAWINGS

FIG. 1A depicts a block diagram of a reduced distortion transmitter according to an example implementation of the present disclosure.

FIG. 1B depicts a block diagram of an example implementation of the sequence transformation block of FIG. 1A.

FIG. 2 illustrates an example modulator.

FIG. 3 illustrates an example implementation of the sequence select circuitry of FIG. 1B.

FIG. 4 depicts an example receiver operable to receive communications from the transmitter of FIGS. 1A and 1B.

FIG. 5 depicts an example 16QAM constellation.

### DETAILED DESCRIPTION OF THE INVENTION

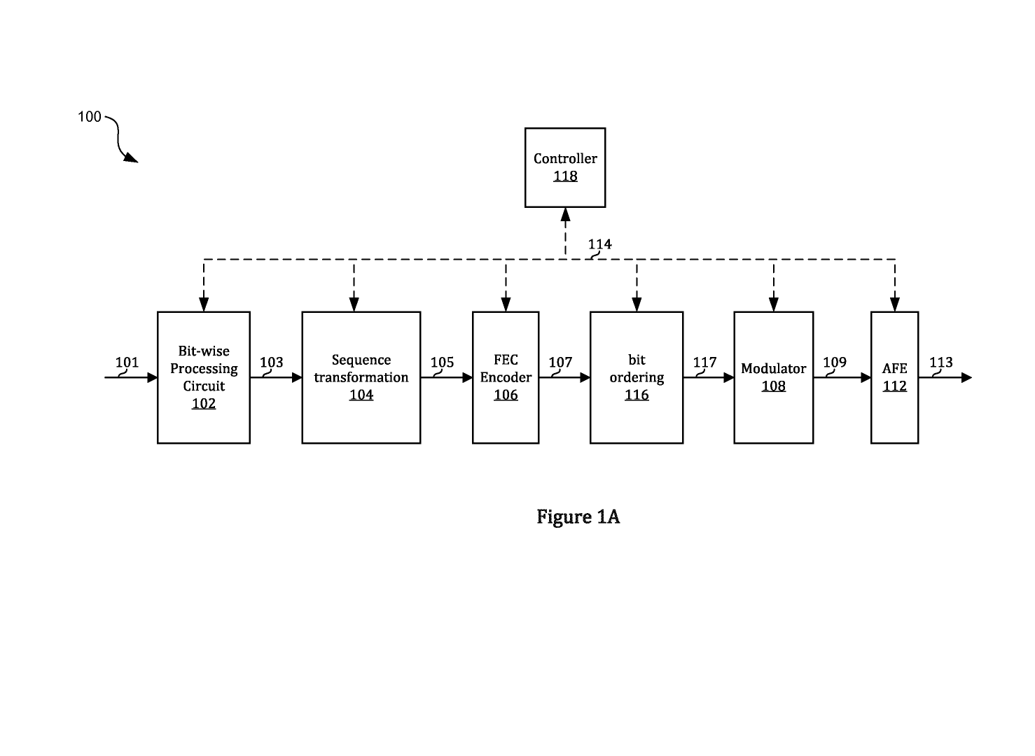

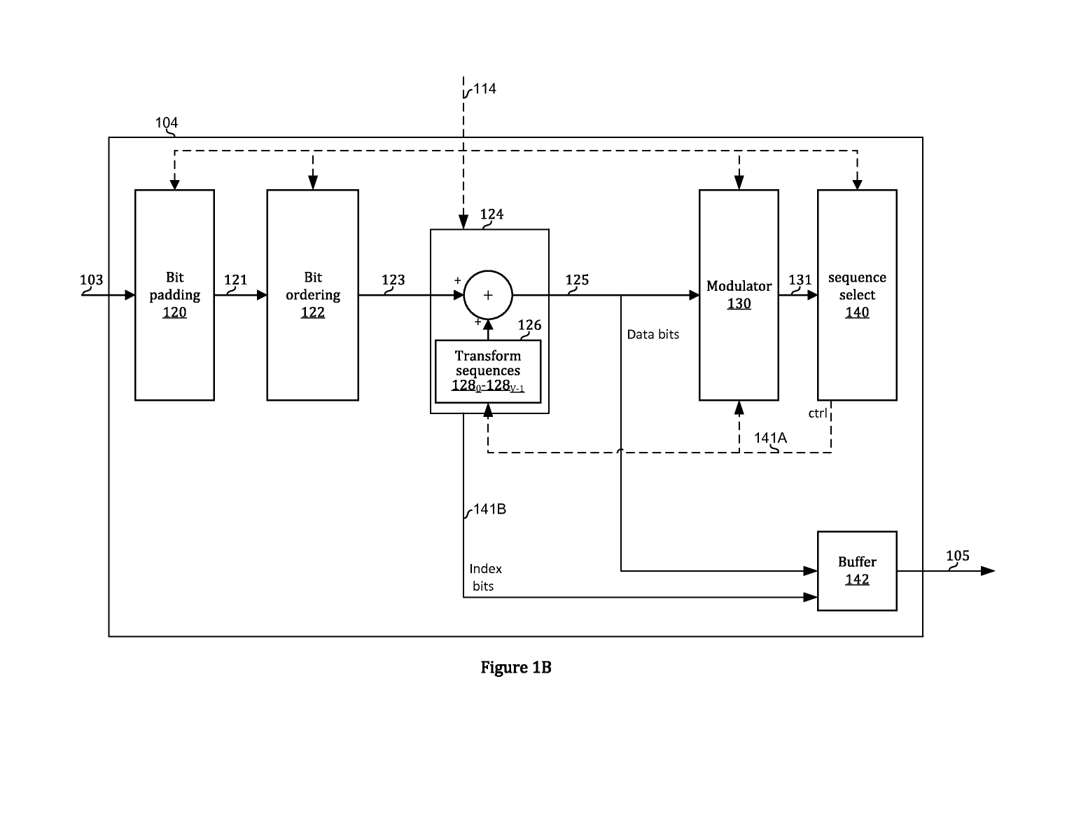

FIG. 1 depicts a general block diagram of a reduced distortion transmitter according to an example implementation of the present disclosure. The example transmitter 100 comprises bit-wise processing circuit 102, sequence transformation circuit 104, forward error correction (FEC) encoder circuit 106, bit ordering circuit 116, modulator circuit 108, analog front-end (AFE) circuit 112, and controller 118.

The controller 118 is operable to perform, via control bus 114, management and configuration of the depicted physical layer components of the transmitter 100. Such configuration may include, for example, configuring various parameters for framing, bit ordering, FEC encoding, and/or other operations of the transmitter discussed below.

The bit-wise processing circuit 102 is operable to process a plurality of data digits 101 to generate a plurality of data digits 103. This processing may include, for example, scrambling, interleaving, parsing, and/or any bit-oriented operation. The resulting data digits 103 are routed to the sequence transformation circuit 104. For the remainder of this disclosure it will be assumed that the digits are binary digits (“bits”), but such is not necessarily the case in all implementations.

The sequence transformation circuit 104 is operable to: (1) select, for the plurality of data bits 103, which one or more transformation sequences provides a best, or at least suitable, value of one or more metrics; (2) transform the plurality of data bits 103 using the determined sequence(s); and (3) output the transformed bits, along with index bits that indicate the selected sequence(s), as a group of bits 105. An example implementation of the circuit 104 is shown in FIG. 1B, to which attention is now directed.

In FIG. 1B, the plurality of data bits 103 are received by bit padding circuit 120 which appends and/or inserts bits to the bits 103 such that the resulting mock codeword 121 is equal to N_{tbcw}, which is the total number of bits of the codeword that the plurality of bits 103 will be encoded into by FEC encoder 106 (FIG. 1A). In an example implementation of this disclosure, a codeword comprises N_{dbcw} data bits, N_{ibcw} index bits, and N_{rbcw} redundancy bits, and thus N_{tbcw}=N_{dbcw}+N_{ibcw}+N_{rbcw}. In such an implementation, the circuit 120 may append N_{ibcw} mock index bits to the N_{dbcw} data bits 103, and then append N_{rbcw} mock redundancy bits after the index bits. In this manner, the mock codeword 121 mocks a systematic codeword having information bits (the data bits and index bits) embedded in the mock codeword 121 along with the redundancy bits that protect those information bits. Example implementations discussed in this disclosure assume that N_{tbcw} is larger than the number of coded bits per OFDM symbol, N_{cbs}, and thus a particular codeword may be transmitted over N_{tbcw}/N_{cbs} OFDM Symbols. In other implementations, however, N_{tbcw} may be smaller than N_{cbs}, and thus N_{cbs}/N_{tbcw} codewords may be transmitted during a single OFDM symbol.

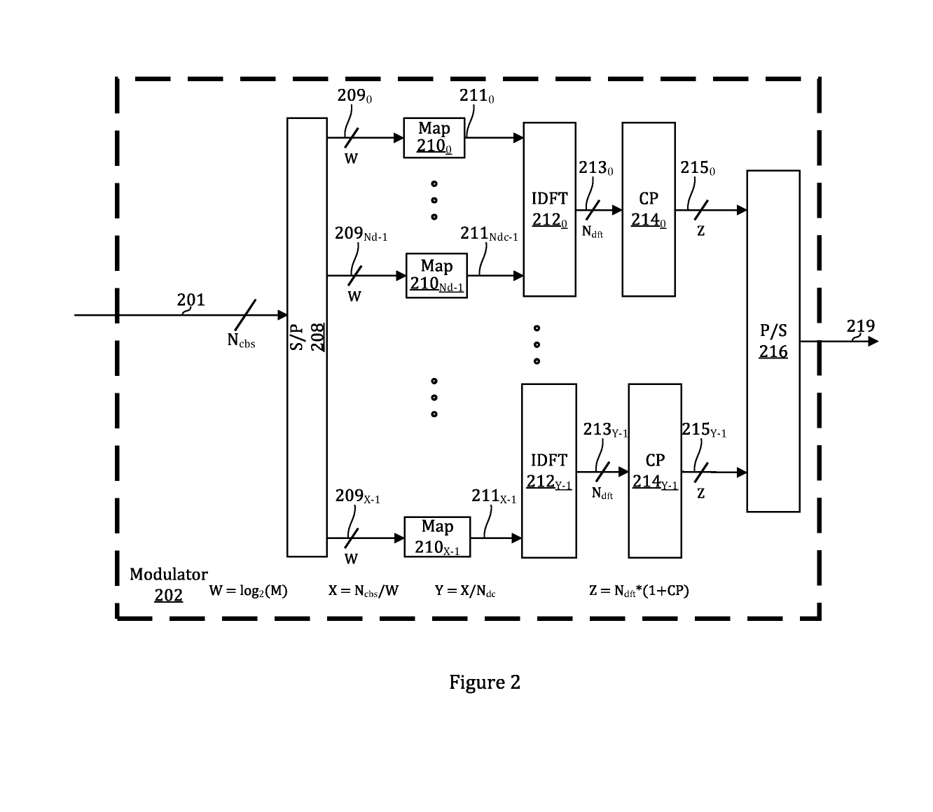

The bit ordering circuit 122 is operable to receive one or more mock codewords 121 and order (or re-order) the bits of the mock codeword(s) 121. The ordering may be based on the numbers and/or positions of different types (e.g., data, index, and redundancy) of bits within the mock codeword(s) 121, on the boundaries between OFDM symbols, on the boundaries between mock codewords 121, and on the number of bits per data carrier (N_{bdc}). The ordering may attempt to place at least some of the data bits of the mock codeword(s) 121, at least some of the redundancy bits of the mock codeword(s) 121, and at least some of the index bits of the mock codeword(s) 121 in each of the mock OFDM symbols across which the mock codeword(s) 121 span(s) (e.g., the ordering may attempt to uniformly distribute each of the types of bits across the mock OFDM symbols.) Furthermore, the ordering may attempt to: (1) place data bits at positions within the mock OFDM symbol(s) which, when demultiplexed to one or more constellation mappers 210 (FIG. 2) of the modulator 130, correspond to higher-energy-impact inputs of the mapper(s) 210; and (2) place index bits and redundancy bits at positions within the mock OFDM symbol(s) which, when demultiplexed to one or more constellation mappers 210 (FIG. 2) of the modulator 130, correspond to lower-energy-impact inputs of the mapper(s) 210. In performing the ordering, the bit ordering circuit 122 may maintain the order of each type (e.g., data, index, or redundancy) of bits relative to the other bits of the same type (while the relative order between different types of bits changes). Thus, using the data bits as an example, if serially scanning starting from position 0, the data bits would be encountered in the same order in the mock codeword(s) 121 as in the ordered mock codeword(s), but any particular data bit may be encountered at a different position in the ordered mock codeword(s) than its position in the mock codeword(s) 121. The ordering may result in N_{dbs}, N_{rbs}, and N_{ibs} varying from OFDM symbol to OFDM symbol.

The ordered mock codeword(s) generated by the bit ordering circuit 122 are input to sequence transformation circuit 124 in groups of bits 123 comprising N_{cbs} bits each, where the N_{cbs} bits consist of N_{dbs} data bits, N_{rbs} redundancy bits, and N_{ibs} index bits. That is, sequence transformation circuit 124 operates on an OFDM symbol's worth of bits at a time. For each bit group 123, the N_{ibs} index bits and the N_{rbs} redundancy bits may pass through the sequence transformation circuit 124 unaffected (or simply bypass the sequence transformation circuit 124). The N_{dbs} data bits of the bit group 123, however, are transformed by up to V (an integer greater than 1) transform sequences 128, to generate up to V of the transformed bit groups 125ᵥ. Each of the transformed bit groups 125ᵥ is associated with a respective index value v, which takes on values from 0 to V−1. Thus, to uniquely represent the V transform sequences 128₀-128_{V-1}, the number of index bits per OFDM symbol (N_{ibs}) is equal to at least ceil(log₂(V)). Examples of transformations which may be performed on the data bits of an OFDM symbol include: adding (exclusive-OR) bit sequence 128ᵥ to the N_{dbs} data bits of bit group 123, scrambling the N_{dbs} data bits of bit group 123, interleaving the N_{dbs} data bits of bit group 123, applying some logical operation to the N_{dbs} data bits of bit group 123, etc. The generated one or more of the transformed bit groups 125ᵥ are output (sequentially or in parallel, depending on the implementation) to the modulator 130.

The modulator 130 modulates each of the generated one or more transformed bit groups 125ᵥ onto a plurality of subcarriers. Operations performed by the modulator 130 may include, for example, symbol constellation mapping, precoding, IDFT (Inverse Discrete Fourier Transform), interpolation, decimation, and/or other processing procedures related to the specific modulator. The modulator 130 outputs up to V of the modulated signals 131ᵥ for each OFDM symbol of the current mock codeword 121. Details of an example implementation of the modulator 130 are described below with reference to FIG. 2.

The sequence select circuit 140 measures one or more values for each of one or more metric(s) for the generated one or more modulated signals 131ᵥ. For a particular signal 131ᵥ corresponding to a particular OFDM symbol, the metric(s) may comprise, for example, peak-to-average-power ratio (PAPR), peak signal level, Cubic Metric (CM), Error Vector Magnitude (EVM), and/or any other metric that quantifies or assesses the amount of distortion that will be introduced when signal 131ᵥ is processed by nonlinear circuitry, such as a power amplifier (PA), of the AFE 112 (FIG. 1). For each mock OFDM symbol, a signal 131ᵥ will be selected for transmission only if its metric value(s) meets an applicable criterion (or criteria) and/or is/are the best among the metric values(s) for the one or more modulated signals 131ᵥ generated for that particular OFDM symbol.

For each mock OFDM symbol, the N_{dbs} transformed data bits of the selected transformed bit group 125ᵥ is buffered, along with the index bits 141B representing the index v of the selected transformed bit group 125ᵥ, for output in buffer 142. After the best transformed bit group 125ᵥ and corresponding index bits for each of the mock OFDM symbols of a mock codeword 121 have been buffered in buffer 142, the N_{dbcw} transformed data bits (i.e., transformed version of the plurality of data bits 103) and the associated N_{ibcw} index bits are output as bit group 105.

Returning to FIG. 1A, the bit group 105, comprising N_{dbcw} data bits and N_{ibcw} index bits, are input to FEC encoder 106 which performs an FEC encoding algorithm (e.g., Reed-Solomon, LDPC, Turbo, or some other algorithm) to generate N_{rbcw} redundancy bits that protect the data bit and index bits. One or more codewords 107 generated in this manner, each comprising data bits, index bits, and redundancy bits, is/are output to bit ordering circuit 116.

The ordering circuit 116 operates the same as the ordering circuit 122 described above. In an example implementation, the ordering determined by ordering circuit 122 for one or more mock codeword(s) 121 is simply copied/replicated by the bit ordering circuit 116 for the corresponding codeword(s) 107. The ordered codeword(s) is/are output in bit groups 117, each of which corresponds to an OFDM symbol and comprises N_{cbs} bits. In an example implementation, the bit ordering circuitry 116 may be integrated with the FEC encoder 106.

The modulator 108 modulates each of the bit groups 117 onto a plurality of subcarriers to generate a time domain digital baseband OFDM symbol 109. Operations performed by the modulator 108 may include, for example, symbol constellation mapping, precoding, IDFT (Inverse Discrete Fourier Transform), interpolation, decimation, and/or other processing procedures related to the specific modulator. Details of an example implementation of the modulator 130 are described below with reference to FIG. 2.

For each time domain digital baseband OFDM symbol 109, the AFE 112 performs operations to make the OFDM symbol suitable for transmission onto the channel. Such processing may comprise, for example, upconversion, filtering, conversion to analog, and power amplification. When a time domain digital baseband OFDM symbol 109 has a large dynamic range, the resulting signal at the output of a PA of the AFE 112 may be distorted as a result of high signal levels being compressed by the PA as nears its saturation or compression level. In the transmitter 100, the use of the sequence transformation circuit 104 reduces such distortion relative to a transmitter lacking such a sequence transformation circuit 104.

A framing scheme used in the transmitter 100 may be designed to ensure that any frame contains an integer number of codewords and an integer number of OFDM symbols. Based on the amount of data to be transmitted, a framing schemes typically adapt one or both of: the total number of bits per codeword (N_{tbcw}), and the number of data bits per codeword (N_{dbcw}) in order to maintain an integer number of codewords and OFDM symbols per frame. This adaptation may be constrained/controlled such that the code rate (N_{dbf}/N_{tbf}) does not stray too far from a target code rate (Rₜ). A framing scheme in accordance with an example implementation of this disclosure accounts for the N_{ibs} index bits per OFDM symbol that are added as a result of the sequence transformation. A couple of example framing schemes will help illustrate.

As a first example, assume the number of data bits to be transmitted in a frame (N_{dbf}) is 8000, the required code rate (Rₜ) is ¾, the number of data carriers per OFDM symbol (N_{dc}) is 52, the number of bits per carrier (N_{bdc}) is 10, and the number of coded bits per symbol (N_{cbs}) is N_{dc}*N_{bdc}=520. Further assume that V=4, and thus N_{ibs}=2. First, an initial estimation of the number of symbols needed for the frame (N_{sf}) is calculated as ceil(N_{dbf}/N_{cbs}/Rₜ)=21. Next, it is determined whether the addition of the N_{ibs}*N_{sf} index bits will require N_{sf} to be increased. In this regard, if ceil((N_{dbf}+(N_{ibs}*N_{sf}))/N_{cbs}/Rₜ)>ceil(N_{dbf}/N_{cbs}/Rₜ), then the initial estimate of N_{sf} is increased by 1. In this example, ceil((N_{dbf}+(N_{ibs}*N_{sf})/N_{cbs}/Rₜ) is also 21, so the number of symbols is unaffected by the addition of the index bits. The N_{sf} symbols are then allocated among N_{cwf} codewords. Accordingly, the N_{ibs}*N_{sf} index bits are also allocated among the N_{cwf} codewords. One possibility for such allocation is that, for any particular codeword, N_{ibcw} corresponds to N_{ibs}*N_{ends}, where N_{ends} is the number of symbols that end in that codeword. This can be expressed as N_{ibcw}=diff([0;floor(cumsum(N_{tbcw})/N_{cbs})])*N_{ibs}. To illustrate with concrete numbers, assume N_{cwf}=6 and the framing scheme—not yet accounting for the index bits—arrives at a frame consisting of the following six codewords: (1333,1819), (1333,1819), (1333,1820), (1333,1820), (1334,1821), (1334,1821), where each codeword is represented as (N_{dbcw}, N_{tbcw}) (thus N_{dbf}=1333+1333+1333+1333+1334+1334=8000, N_{tbf}=1819+1819+1820+1820+1821+1821=10920, and the actual code rate (Rₐ)=0.7326). Thus:
symbols 0 to 2 (bits 0 to 1559) end in the first codeword, N_{ends}=3; N_{ibcw}=6
symbols 3 to 5 (bits 1560 to 3119) end in the second codeword, N_{ends}=3; N_{ibcw}=6
symbols 6 to 9 (bits 3120 to 5199) end in the third codeword, N_{ends}=4; N_{ibcw}=8
symbols 10 to 12 (bits 5200 to 6759) end in the fourth codeword, N_{ends}=3; N_{ibcw}=6
symbols 13 to 16 (bits 6760 to 8839) end in the fifth codeword, N_{ends}=4; N_{ibcw}=8
symbols 17 to 20 (bits 8840 to 10919) end in the sixth codeword, N_{ends}=4; N_{ibcw}=8
   Therefore, the final frame including the index bits consists of the following six codewords: (1333+6,1819), (1333+6,1819), (1333+8,1820), (1333+6,1820), (1334+8,1821), (1334+8,1821), where each codeword is represented as (N_{dbcw}+N_{ibcw}, N_{tbcw}) (thus N_{dbf}+N_{ibf}=1333+1333+1333+1333+1334+1334+42=8042, N_{tbf}=1819+1819+1820+1820+1821+1821=10920, and the actual code rate (Rₐ)=0.7364).

As a second example, assume the number of data carriers per OFDM symbol (N_{dc}) is fixed, and the number of bits per carrier (N_{bdc}) is fixed, and thus the number of coded bits per symbol (N_{cbs}) is fixed. Further assume that the number of symbols per frame (N_{sf}) is fixed. A framing scheme not accounting for index bits may select N_{tbcw} such that N_{cbs}*N_{sf}/N_{tbcw} is an integer and then adapt N_{dbcw} per codeword based on the total number of data bits (N_{dbf}) to be transmitted in the frame. To account for index bits, the framing algorithm may treat the index bits the same as the data bits and thus adapt N_{dbcw}+N_{ibcw} per codeword based on the total number of data bit and index bits, N_{dbf}+N_{ibf}, to be transmitted during the frame.

FIG. 2 illustrates an example orthogonal frequency division multiplexing (OFDM) modulator representing an example implementation of the modulator 108 (FIG. 1A) and the modulator 130 (FIG. 1B). The modulator 202 receives, serially, N_{cbs} bits 201 corresponding to a frequency domain representation of an OFDM symbol (i.e., corresponding to a bit group 117 in FIG. 1A or a bit group 125 in FIG. 1B). The N_{cbs} serial bits are then converted to a parallel representation by serial-to-parallel conversion circuit 208. Groups of W bits, where W=log₂(M) and M is the constellation size, are output by S/P converter 208 as groups 209₀-209_{X-1}, where X=N_{cbs}/W. Each group of bits 209ₓ (x being an integer, where 1≦x≦X) is mapped to a subcarrier 211ₓ by mapper 210ₓ.

In an example implementation the S/P circuit 208 may perform “vertical” parallelization of the bits 201 such that each subcarrier is filled before moving onto the next subcarrier. That is, the first W bits of bits 201 are output as 209₀, the next W bits are output as 209₁ and so on. For example, if n_{bdc}=10, N_{dc}=224, N_{cbs}=2240, N_{tbcw}=1944, and a particular OFDM symbol comprises 125 bits of a first codeword, CW 1944 bits of a second codeword, and 171 bits of a third codeword, vertical parallelization results in a codeword boundaries on subcarrier 13 and subcarrier 207.

In an example implementation the S/P circuit 208 may perform “horizontal” parallelization of the bits 201 such that multiple subcarriers are filled concurrently. That is, the first bit of bits 201 is output as 209₀, the next bit is output as 209₁ and so on. For example, if n_{bdc}=10, N_{dc}=224, N_{cbs}=2240, N_{tbcw}=1944, and a particular OFDM symbol comprises 125 bits of a first codeword, CW 1944 bits of a second codeword, and 171 bits of a third codeword, horizontal parallelization results in each of subcarriers 1 through 125 comprising 1 bit from the first codeword, and so on.

For each mapper 210ₓ (x an integer, where 0≦x≦X), lower-energy-impact inputs of the W inputs may, in general (at least more often than would occur by random chance), receive redundancy or index bits, and higher-energy-impact inputs of the W inputs may, in general (at least more often than would occur by random chance), be transformed data bits. As an example for purposes of illustration and not limitation, assuming a code rate of ¾, W=10, and that the energy impact of the W inputs monotonically increases from bit position 0 to bit position 9, then the ordering may be such that (with some desired statistical certainty for which the system is configured) redundancy and index bits will be confined to inputs 0 through 4 for each of the mappers 210₀-210_{X-1}.

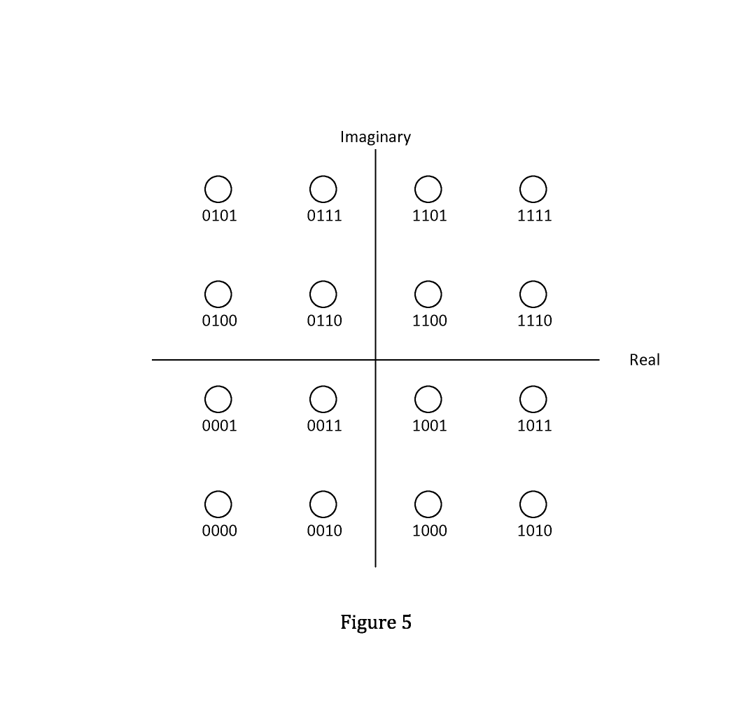

To illustrate the energy impact of a mapper input, consider a simplified example of a 12-bit OFDM symbol consisting of 8 data bits, 2 index bits, and 2 redundancy bits (denoted here as ddddddddiirr), and assume the mappers 210 map according to the 16QAM constellation (W=4) shown in FIG. 5, where the inputs of a mapper 210 are denoted b₀b₁b₂b₃, b₀b₂ maps to the real axis, and b₁b₃ maps to the imaginary axis. Looking at the real axis, it is seen that b₂ has more impact on the energy of the resulting mapped symbol than b₀. Similarly, looking at the imaginary axis, b₃ has more impact on the energy of the resulting mapped symbol than b₁. Thus, for this example mapper, b₃ and b₂ are higher-energy-impact inputs and b₁ and b₀ are lower-energy-impact inputs. Thus, in order to minimize the impact of the index and redundancy bits on EVM in this example, the bit ordering performed by bit ordering circuit 116 (FIG. 1A) and bit ordering circuit 122 (FIG. 1B) may be such that the index and redundancy bits end up (with some statistically certainty) at inputs b₀ and/or b₁ of the mappers 210, and not at inputs b₂ and/or b₃ of the mappers 210.

Each group of N_{dc} subcarriers 211 output by mappers 210₀-210_{X-1} is conveyed to a respective one of inverse discrete Fourier transform (IDFT) circuits 212₀-212_{Y-1}, where Y=X/N_{dc}. The IDFT size is N_{dft}, which is greater than N_{d} such that there are N_{dft}-N_{dc} non-data-carrying subcarriers available for use as pilots, guard bands, and/or as DC carriers. Each IDFT 212_{y} (y being an integer, where 1≦y≦Y) outputs N_{dft} samples as signal 213_{y}. As one non-limiting example: N_{cbs} is 520 bits, the size of the constellation (M) is 1024, W is 10 bits, the number of constellation mappers (X) is 52, the number of IDFT circuits (Y) is 1, the number of data carrying subcarriers (N_{dc}) is 52, and the size of the IDFT circuits (N_{dft}) is 64, leaving 12 non-data-carrying subcarriers (e.g., 4 pilots and 12 guard bands). Each cyclic-prefix insertion circuit 214, then adds a cyclic prefix to signal 212y resulting in signal 215_{y} having Z samples, where Z=N_{dft}(1+CP) and CP is the size of the cyclic prefix). The signals 215₁-215_{Y-1} are serialized by P/S circuit 216 resulting in Y*Z samples of signal 219 (corresponding to time domain digital baseband OFDM symbol 109 in FIG. 1A and a mock time domain digital baseband OFDM symbol 131ᵥ in FIG. 1B).

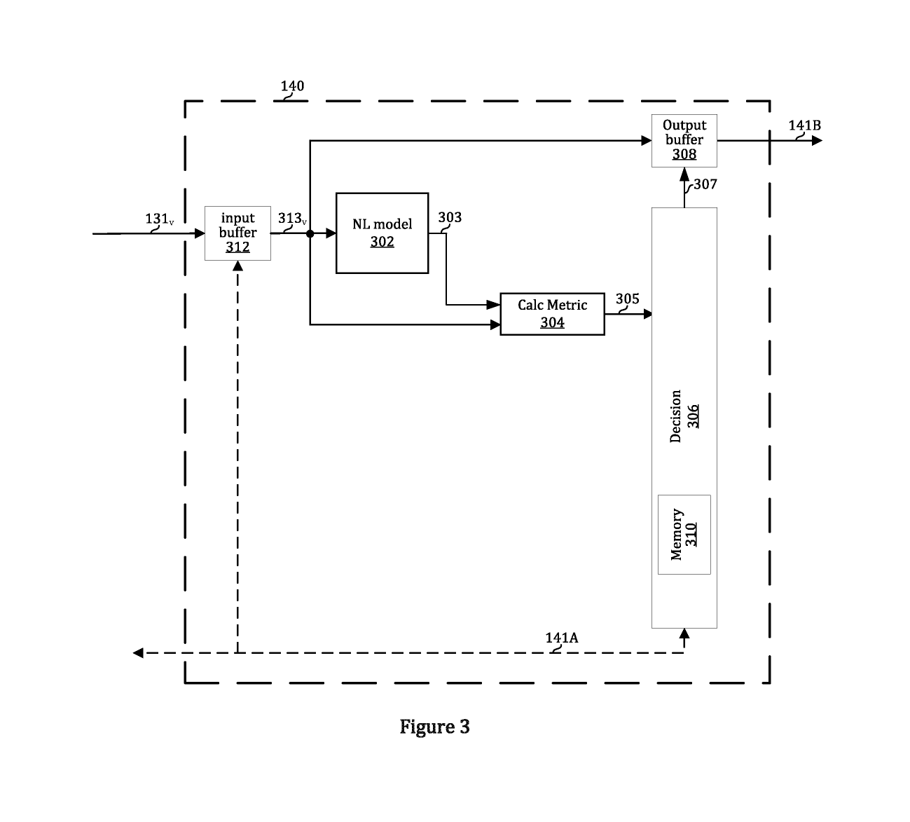

FIG. 3 illustrates an example implementation of the sequence select circuitry of FIG. 1B. The example sequence select circuit 140 comprises an input buffer 312, a nonlinear distortion modeling circuit 302, a metric calculation circuit 304, decision circuitry 306, and output buffer circuit 308. Each signal 131ᵥ of the up to V signals 131ᵥ generated for a particular OFDM symbol, is buffered in input buffer 312 and conveyed, as signal 313, to the output buffer 308, to the nonlinear distortion modeling circuit 302, and to the metric calculation circuit 304. The nonlinear distortion modeling circuit 302 applies a model of the nonlinear distortion introduced by the transmitter 100 to the signal 313, resulting in distorted signal 303, which is an estimate of the actual transmitted signal 113 (FIG. 1A) that would result if the signal 313 were to be transmitted by transmitter 100. In the example transmitter 100, the nonlinear distortion modeling circuit 302 may model nonlinear distortion introduced by the AFE 112. In other transmitters where nonlinear distortion is introduced ahead of the AFE 112, such distortion may also be modeled by the nonlinear distortion modeling circuit 302. Such nonlinear distortion may be the result of, for example, digital predistortion and/or spectral shaping such as described in U.S. patent application Ser. No. 14/687,861 titled “Transmitter Signal Shaping” (which is hereby incorporated herein by reference).

The metric calculation circuit 304 calculates one or more metric values 305 based on the signal(s) 313 and/or 303. The metric(s) may comprise any one or more of the following: minimal error vector magnitude (EVM) (where EVM is defined as the difference between the input and output of the nonlinear distortion modeling circuitry 302), minimal peak EVM, minimal peak energy at the input of the nonlinear distortion modeling circuitry 302, minimum average energy at the input of the nonlinear distortion modeling circuitry 302, cubic metric, and any other measure that quantifies or assesses the amount of distortion in signal 303. The value(s) for the metric(s) may be calculated over a continuous frequency band spanned by one or both of the signals 313 and 303 and/or in a selected one or more (possibly discontiguous) subbands occupied by one or both of the signals 313 and 303. For example, requiring EVM energy in out-of-band frequencies to be below a threshold, or as low as possible, can improve compliance with a spectral mask set forth by a regulatory body.

The decision circuit 306 then evaluates the value(s) of the metric(s) 305 to determine whether the signal 313 should selected for transmission (i.e., trigger it, via signal 307, to be latched into output buffer 308) and/or whether another signal 313 is to be checked for the current OFDM symbol, or whether to move on to the next OFDM symbol.

Determining whether to select the current signal 313 for transmission, may be carried out in a variety of ways. As a first example, the decision circuitry 306 may compare the metric value 305 for the current signal 313 to a threshold value for the metric, and, if it is above (or below, as the case may be) the threshold, the current signal 313 may be latched into the output buffer 308 for output to the AFE 112. If the metric for the current signal 313 is not above (or below, as the case may be) the threshold, the decision circuit 306 may trigger the check of a next signal 313. As a second example, the decision circuitry 306 may compare the metric value 305 for the current signal 313 to metrics stored in memory 310 for previous signals 313 of the same OFDM symbol, and, if the current signal 313 is the best one yet for the current OFDM symbol, it may be latched into the output buffer 308 for output to the AFE 112.

Triggering the check of another signal 313 may also be carried out in a variety of ways. As a first example, after checking signal 313 corresponding to signal 131ᵥ for the current OFDM symbol, signal 141A may trigger the sequence transformation circuit 124 to generate a next transformed big group 125ᵥ₊₁ for the current OFDM symbol, which is then modulated by modulator 130 to become the signal 131ᵥ₊₁, which, in turn, is buffered to become the signal 313 for the current OFDM symbol. In this first example, each successive transformed bit group 125ᵥ and modulated signal 131ᵥ is generated on-demand and thus such an implementation may be used where it is desired to avoid unnecessary activity in the sequence transformation circuit 124 and the modulator 130. As a second example, after checking 313 corresponding to signal 131ᵥ for the current OFDM symbol, signal 141A may trigger the modulator 130 to modulate the next transformed bit group 125_{V+1} for the current OFDM symbol, which was previously generated by the sequence transformation circuit 124 (e.g., all transformed bit groups 125₀-125_{V-1} were generated at once and are sitting in an output buffer of the sequence transformation circuit 124) to generate the signal 131ᵥ₊₁ for the current OFDM symbol which, in turn, is buffered to become signal 313. As a third example, the signal 141A may trigger the release of a previously buffered signal 131ᵥ₊₁ as signal 313.

The foregoing has described a fully sequential arrangement in which each of the N_{tbcw}/N_{cbs} OFDM symbols of a particular codeword is processed sequentially by a single modulator 130, and, for each such OFDM symbol, the up to V signals 131ᵥ are processed sequentially by a single sequence select circuit 140. In other implementations, however, multiple instances of the modulator 130 and/or multiple instances of the sequence select circuit 140 may be used to partially or fully parallelize such operations. For example, the N_{tbcw}/N_{cbs} OFDM symbols of a particular codeword may be processed sequentially by a single modulator 130, and the up to V signals 131ᵥ of each such OFDM symbol may be processed in parallel by up to V instances of sequence select circuit 140. As another example, each of the N_{tbcw}/N_{cbs} OFDM symbols of a particular codeword may be modulated in parallel by a respective one of N_{tbcw}/N_{cbs} instances of modulator 130, and then up to V*(N_{tbcw}/N_{cbs}) resulting signals 131ᵥ may be processed in parallel by up to V*(N_{tbcw}/N_{cbs}) instances of sequence select circuit 140.

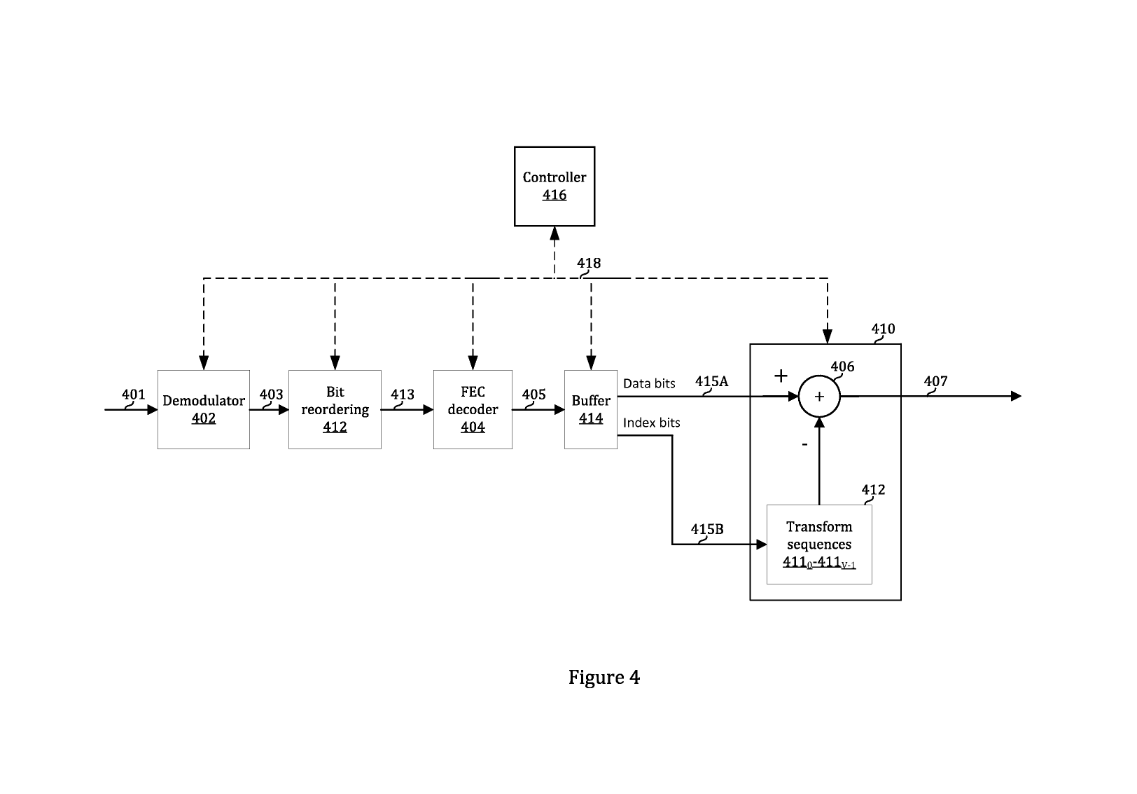

FIG. 4 depicts a receiver capable of receiving a signal which is generated by the transmitter 100. Time-domain OFDM symbols 401 are received over the channel and demodulated by demodulator 402 to recover encoded bits. The encoded bits are buffered until a one or more full codewords is received and then a group of N_{tbcw} bits 403 (the received version of a transmitted bit group 117) are conveyed to bit ordering circuit 412. Ordering of the bits 403 by ordering circuit 412 may operate to undo the ordering performed by the bit ordering circuit 116. The resulting encoded codeword(s) 413 (the received version of codeword(s) 107) is/are then decoded by FEC decoder 404. The resulting decoded codeword(s) 405 is/are buffered in buffer 414. One OFDM symbol's worth of data bits and index bits at a time are pulled from the buffer 414. That is, N_{cbs}+N_{ibs} bits at a time are pulled from buffer 414, with the N_{cbs} data bits 415A being conveyed to sequence transformation circuit 410 for transformation (i.e., applied to a first input of adder 406 in the example shown), and the N_{ibs} index bits (which are at a deterministic position in the decoded codeword 405) being conveyed to sequence transformation circuit 410 for selecting the transform sequence 411ᵥ that corresponds to the transform sequence 128ᵥ applied to the data bits of the OFDM symbol in the transmitter 100. The selected transform sequence 411ᵥ is applied to a second input of adder 406 in the example shown. The resulting (de)transformed bits 407 are the received data bits corresponding to bits 103 in the transmitter 100.

The controller 416 is operable to perform, via control bus 418, management and configuration of the depicted physical layer components of the receiver 400. Such configuration may include, for example, configuring various parameters for bit ordering, FEC decoding, and/or other operations of the transmitter discussed above.

Any of the size/length parameters discussed in this disclosure may vary from codeword to codeword, from OFDM symbol to OFDM symbol of a particular codeword, and/or otherwise. The variance may depend, for example, on the framing scheme in use.

In accordance with an example implementation of this disclosure, a transmitter (e.g., 100) comprises sequence transformation circuitry (e.g., 104), FEC encoder circuitry (e.g., 106), and modulator circuitry (e.g., 108 and/or 130). The sequence transformation circuitry is operable to apply a first transformation sequence (e.g., 128ᵥ) to first data bits to generate first transformed data bits (e.g., 125ᵥ), and apply a second transformation sequence (e.g., 128ᵥ₊₁) to second data bits to generate second transformed data bits (e.g., 125ᵥ₊₁) The FEC encoder circuitry is operable to generate redundancy bits based on the first transformed data bits, one or more first index bits representing an index of the first transformation sequence, the second transformed data bits, and one or more second index bits representing an index of the second transformation sequence. The FEC encoder circuitry is operable to output a codeword comprising the first transformed data bits, the first index bits, the second transformed data bits, the second index bits, and the redundancy bits. The modulator circuitry is operable to generate a first OFDM symbol carrying the first transformed data bits, the first index bits, and a first portion of the redundancy bits, and generate a second OFDM symbol carrying the second transformed data bits, the second index bits, and a second portion of the redundancy bits. The sequence transformation circuitry may be operable to select the first transformation sequence from a plurality of possible transformation sequences based on a value of a metric measured for the first transformed data bits, and select the second transformation sequence from the plurality of possible transformation sequences based on a value of the metric measured for the second transformed data bits. The value of the metric measured for the first transformed data bits may quantify an amount of distortion that will be introduced when the first transformed data bits are processed by nonlinear circuitry of the transmitter. The value of the metric measured for the second transformed data bits may quantify an amount of distortion that will be introduced when the second transformed data bits are processed by nonlinear circuitry of the transmitter. The metric may be error vector magnitude, peak-to-average-power ratio, or the cubic metric. The sequence transformation circuitry may be operable to model nonlinear circuitry of the transmitter for the measurement of the metric values. The transmitter may comprise circuitry (e.g., controller 118) operable to determine a number of OFDM symbols to be used for transmission of a frame's worth of data bits based on how many sequences are in the plurality of possible sequences. Application of the first transformation sequence to the first data bits may comprises an exclusive-or of the first transformation sequence and the first data bits. Application of the second transformation sequence to the second data bits may comprise an exclusive-or of the second transformation sequence and the second data bits. The transmitter may comprise bit ordering circuitry (e.g., 122 and/or 116) operable to order bits of the codeword prior to the bits of the codeword being input to the modulator. The bit ordering circuitry may be operable to order the bits of the codeword such that transformed data bits are more likely than the first index bits, the second index bits, and the redundancy bits to be placed on higher-energy-impact inputs of one or more constellation mappers of said modulator.

In accordance with an example implementation of this disclosure, a transmitter comprises forward error correction encoder circuitry (e.g., 106), modulator circuitry (e.g., 108 and/or 130) comprising constellation mappers (e.g., 210₀-210_{X-1}), and bit ordering circuitry (e.g., 122 and/or 116). The FEC encoder circuitry is operable to generate redundancy bits based on a plurality of data bits and output a codeword comprising the plurality of data and the redundancy bits. The modulator circuitry is operable to generate an OFDM symbol carrying the first transformed data bits and the redundancy bits. The bit ordering circuitry is operable to determine an order in which bits of the codeword are applied to a plurality of inputs of the constellation mapper, based on a respective energy-impact of each of the plurality of inputs. The bit ordering may, for example, ensure as many of the redundancy bits as possible (there may be more redundancy bits than lower-energy-impact inputs) are placed on lower-energy-impact inputs. The bit ordering may, for example, ensure as many of the data bits as possible (there may be more data bits than higher-energy-impact inputs) are placed on higher-energy-impact inputs of one or more constellation mappers of the modulator. The bit ordering may, for example, be such that more data bits end up at higher-energy-impact inputs than is likely to occur from random chance (random ordering of the data and redundancy bits). The bit ordering may, for example, be such that more redundancy bits end up at lower-energy-impact inputs than is likely to occur from random chance (random ordering of the data and redundancy bits). The bit ordering may, for example, be a reordering be such that more data bits end up at higher-energy-impact inputs than would occur from the order of the bits prior to the reordering. The bit ordering may, for example, be a reordering be such that more redundancy bits end up at lower-energy-impact inputs than would occur from the order of the bits prior to the reordering. The bit ordering may, for example, be such that the average energy impact per redundancy bit is less than the average energy impact per data bit.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

The present method and/or system may be realized in hardware, software, or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

1. A transmitter comprising:
sequence transformation circuitry operable to:
apply a first transformation sequence to first data bits to generate first transformed data bits;
apply a second transformation sequence to second data bits to generate second transformed data bits;
forward error correction encoder circuitry operable to:
generate redundancy bits based on said first transformed data bits, one or more first index bits representing an index of said first transformation sequence, said second transformed data bits, and one or more second index bits representing an index of said second transformation sequence;
output a codeword comprising said first transformed data bits, said first index bits, said second transformed data bits, said second index bits, and said redundancy bits;
modulator circuitry operable to:
generate a first OFDM symbol carrying said first transformed data bits, said first index bits, and a first portion of said redundancy bits; and
generate a second OFDM symbol carrying said second transformed data bits, said second index bits, and a second portion of said redundancy bits.

2. The transmitter of claim 1, wherein said sequence transformation circuitry is operable to:
select said first transformation sequence from a plurality of possible transformation sequences based on a value of a metric measured for said first transformed data bits; and
select said second transformation sequence from said plurality of possible transformation sequences based on a value of said metric measured for said second transformed data bits.

3. The transmitter of claim 2, wherein:
said value of said metric measured for said first transformed data bits quantifies an amount of distortion that will be introduced when said first transformed data bits are processed by nonlinear circuitry of said transmitter; and
said value of said metric measured for said second transformed data bits quantifies an amount of distortion that will be introduced when said second transformed data bits are processed by nonlinear circuitry of said transmitter.

4. The transmitter of claim 2, wherein said metric is error vector magnitude.

5. The transmitter of claim 2, wherein said metric is peak-to-average-power ratio.

6. The transmitter of claim 2, wherein said metric is cubic metric.

7. The transmitter of claim 2, wherein said sequence transformation circuitry is operable to model nonlinear circuitry of said transmitter for said measurement of said value of said metric for said first transformed data bits and measurement of said value of said metric for said second transformed data bits.

8. The transmitter of claim 1, comprising circuitry operable to determine a number of OFDM symbols to be used for transmission of a frame's worth of data bits based on how many sequences are in said plurality of possible sequences.

9. The transmitter of claim 1, wherein:
application of said first transformation sequence to said first data bits comprises an exclusive-or of said first transformation sequence and said first data bits; and
application of said second transformation sequence to said second data bits comprises an exclusive-or of said second transformation sequence and said second data bits.

10. The transmitter of claim 1 comprising bit ordering circuitry operable to order bits of said codeword prior to said bits of said codeword being input to one or more constellation mappers of said modulator.

11. The transmitter of claim 10, wherein said bit ordering circuitry is operable to order said bits of said codeword such that transformed data bits are more likely than said first index bits, said second index bits, and said redundancy bits to be placed on higher-energy-impact inputs of said one or more constellation mappers of said modulator.

12. A method comprising:
allocating, by control circuitry of a transmitter, a plurality of codewords for transmission of a frame's worth of data bits;
allocating, by said control circuitry, a plurality of OFDM symbols for transmission of a first codeword of said plurality of codewords;
allocating, by said control circuitry, each of a plurality of groups of said data bits to a respective one of said plurality of OFDM symbols;
transforming, by sequence transformation circuitry of said transmitter, said plurality of groups of data bits to a corresponding plurality of groups of transformed data bits using a corresponding plurality of selected transform sequences;
generating, by a forward error correction encoding circuitry of said transmitter, said first codeword, wherein said first codeword comprises said plurality of groups of transformed data bits, a plurality of index bits corresponding to said plurality of selected transform sequences, and a plurality of redundancy bits generated based on said plurality of groups of transformed data bits and said plurality of index bits;
modulating, by modulator circuitry of said transmitter:
a first group of said plurality of transformed data bits, a first one or more of said plurality of index bits, and a first one or more of said redundancy bits onto a plurality of subcarriers to generate a first one of said OFDM symbols; and
a second group of said plurality of transformed data bits, a second one or more of said plurality of index bits, and a second one or more of said redundancy bits onto a plurality of subcarriers to generate a second one of said OFDM symbols.

13. The method of claim 12, comprising selecting, by said sequence transformation circuitry, each of said plurality of selected transform sequences based on a plurality of metric values measured for said plurality of groups of transformed data bits.

14. The transmitter of claim 13, wherein each of said metric values quantifies an amount of distortion that will be introduced when a corresponding one of said plurality of groups of transformed bits is processed by nonlinear circuitry of said transmitter.

15. The transmitter of claim 13, wherein each of said metric values is one of: an error vector magnitude, a peak-to-average power ratio, and cubic metric value.

16. The transmitter of claim 13, wherein said sequence transformation circuitry is operable to model nonlinear circuitry of said transmitter for said measurement of said metric values.

17. The transmitter of claim 12, comprising determining, by said control circuitry, how many of said OFDM symbols among which to allocate said first codeword based on how many sequences from among which each of said plurality of selected transform sequences is selected.

18. The transmitter of claim 12, wherein, for each one of said plurality of groups of data bits, said transforming comprises an exclusive-or of said one of said plurality of groups of data bits with a respective one of said plurality of selected transform sequences.

19. The transmitter of claim 12, comprising ordering, by bit ordering circuitry of said transmitter, bits of said first codeword prior to said bits of said codeword prior to said modulating.

20. The transmitter of claim 19, wherein said ordering is such that said transformed data bits are more likely than said index bits and said redundancy bits to be placed on higher-energy-impact inputs of one or more constellation mappers of said modulator.

21. A transmitter comprising:
forward error correction encoder circuitry that is operable to:
generate redundancy bits based on a plurality of data bits;
output a codeword comprising said plurality of data and said redundancy bits;
modulator circuitry that comprises a constellation mapper and is operable to generate an OFDM symbol carrying said data bits and said redundancy bits; and
bit ordering circuitry that is operable to determine an order in which bits of said codeword are applied to a plurality of inputs of said constellation mapper based on a respective energy-impact of each of said plurality of inputs.
